(19) United States
(12) Patent Application Publication
(10) Pub. No.: US 2024/0238141 A1
(43) Pub. Date: Jul. 18, 2024

(54) EXERCISE DIAGNOSIS AND TREATMENT BED

(71) Applicants: GUANGZHOU YIKANG MEDICAL EQUIPMENT INDUSTRIAL CO., LTD., Guangzhou (CN); FLUXSTATE LIFE SCIENCE (GUANGDONG) CO., LTD., Guangzhou (CN)

(72) Inventors: Jinqiu XING, Guangzhou (CN); Lin WU, Guangzhou (CN); Rixin HUANG, Guangzhou (CN); Yong CHEN, Guangzhou (CN); Xiaolan LI, Guangzhou (CN); Yangfeng ZHENG, Guangzhou (CN)

(73) Assignees: GUANGZHOU YIKANG MEDICAL EQUIPMENT INDUSTRIAL CO., LTD., Guangzhou, GD (CN); FLUXSTATE LIFE SCIENCE (GUANGDONG) CO., LTD., Guangzhou, GD (CN)

(21) Appl. No.: 18/255,963

(22) PCT Filed: Apr. 18, 2022
(86) PCT No.: PCT/CN2022/087401

§ 371 Date: Jun. 5, 2023

(30) Foreign Application Priority Data
Mar. 9, 2022 (CN) 202210230204.9

(51) Int. Cl. A61G 13/06; A61G 13/12

(52) U.S. Cl. CPC A61G 13/06; A61G 13/1245

(57) ABSTRACT

An exercise diagnosis and treatment bed is disclosed, which includes an underframe and a bed body arranged on the underframe, the bed body includes bed board assemblies and driving modules used for being connected with and supporting the bed board assemblies respectively, the bed board assemblies are spaced from each other and used for supporting preset parts of a human body; the driving module includes a first driving mechanism, a second driving mechanism and a third driving mechanism, and the first driving mechanism, the second driving mechanism and the third driving mechanism are used for driving the bed board assembly to rotate around a second rotating shaft, a third rotating shaft and a first rotating shaft respectively; and the exercise diagnosis and treatment bed may further include a control module used for controlling the first driving mechanism, the second driving mechanism and the third driving mechanism.

### TECHNICAL FIELD

The present disclosure relates to the technical field of medical instruments, and particularly to an exercise diagnosis and treatment bed.

### BACKGROUND

At present, in the medical market, there are many diagnosis and treatment beds for treating patients suffering from clinical symptoms such as lumbar disc hemiation, walking weakness, muscular atrophy of legs and feet and cervical spondylosis caused by various acute and chronic injuries. Generally, a bed board of the diagnosis and treatment bed is fixed or adjustable, so that a therapist can arrange a patient into a required posture in manipulative therapy. In this case, the bed board cannot achieve continuous movement, and at least one therapist is needed for auxiliary treatment, so that this kind of diagnosis and treatment bed cannot reduce the burden on the hands of the therapist, thus being time-consuming and laborious to use.

### SUMMARY

The present disclosure aims to solve at least one of the technical problems in the existing technology. Therefore, the present disclosure provides an exercise diagnosis and treatment bed, and continuous movement of the functions such as flexion-extension, lateral bending and rotation of the lumbar vertebra and the cervical vertebra of a patient can be achieved by adjusting the exercise diagnosis and treatment bed, and the purpose of exercise treatment is achieved, so as to reduce the burden on the hands of a therapist and save time and labor.

An exercise diagnosis and treatment bed according to an embodiment in a first aspect of the present disclosure comprises:
an underframe;
a bed body arranged on the underframe, wherein the bed body comprises a plurality of bed board assemblies and a plurality of driving modules, the bed board assemblies are spaced from each other and used for supporting preset parts of a human body, the driving modules are adapted to the bed board assemblies in number, and each of the driving modules is used for being connected with and supporting each of the bed board assemblies;
a space at which the bed board assemblies are located has a first direction, a second direction and a third direction which are perpendicular to each other, and a first rotating shaft is parallel to the first direction, a second rotating shaft is parallel to the second direction and a third rotating shaft is parallel to the third direction;
the driving module comprises a first driving mechanism, a second driving mechanism and a third driving mechanism, the first driving mechanism is used for driving the bed board assembly to rotate around the second rotating shaft, the second driving mechanism is used for driving the bed board assembly to rotate around the third rotating shaft, and the third driving mechanism is used for driving the bed board assembly to rotate around the first rotating shaft; and
a control module used for controlling at least one of the first driving mechanism, the second driving mechanism or the third driving mechanism.

The exercise diagnosis and treatment bed according to the embodiment in the first aspect of the present disclosure has at least the following beneficial effects: the plurality of bed board assemblies are arranged for supporting and fixing a head, a chest and a pelvis of a human body respectively, the plurality of driving modules are adapted to the bed board assemblies respectively, and the driving modules are independently controlled on the basis of the control module, so that the driving modules can adaptively adjust left-right rotation, front-back rotation and plane rotation of the bed board assemblies on the basis of preset logic, and continuous movement of the functions such as flexion-extension, lateral bending and rotation of the lumbar vertebra and the cervical vertebra of a patient is achieved, and the purpose of exercise treatment is achieved, so as to reduce the burden on the hands of a therapist and save time and labor.

For the exercise diagnosis and treatment bed according to the embodiment in the first aspect of the present disclosure, the bed board assembly comprises a first connecting plate, a first connecting member, a cross universal joint, a supporting body and a board body for supporting, the third driving mechanism is arranged on the board body, and the third driving mechanism comprises a third driving assembly and a second connecting plate;
the cross universal joint, the first driving mechanism and the second driving mechanism are arranged on the supporting body, and the first driving mechanism and the second driving mechanism are connected with the cross universal joint;
the first connecting plate is fixedly connected with the board body, the first connecting member is rotatably connected with the first connecting plate with the first rotating shaft as a rotating axis, and one end of the first connecting member is used for supporting the board body;
the other end of the first connecting member is connected with the cross universal joint, so that the first driving mechanism and the second driving mechanism are capable of driving the bed board assembly to rotate around the second rotating shaft and the third rotating shaft respectively; and
the second connecting plate is fixedly connected with the first connecting member, two ends of the third driving assembly are rotatably connected with the first connecting plate and the second connecting plate respectively, and based on fixed connection of the second connecting plate, the third driving mechanism is capable of driving the first connecting plate to rotate the board body around the first rotating shaft through extension and retraction.

For the exercise diagnosis and treatment bed according to the embodiment in the first aspect of the present disclosure, the first driving mechanism comprises a first driving assembly, a first connecting block, a second connecting block, a first connecting rod, a second connecting rod and a second connecting member;
one cross edge of the cross universal joint is fixedly connected with the supporting body, and the other cross edge of the cross universal joint is fixedly connected with the first connecting member and the second connecting member;
one end of the first connecting rod is fixedly connected with the supporting body, and the other end of the first connecting rod is rotatably connected with the first connecting block;
one end of the second connecting rod is fixedly connected with the second connecting member, and the other end of the second connecting rod is rotatably connected with the second connecting block; and
two ends of the first driving assembly are rotatably connected with the first connecting block and the second connecting block respectively, and based on the cross universal joint, the first driving assembly is capable of driving the board body to rotate around the second rotating shaft through extension and retraction.

For the exercise diagnosis and treatment bed according to the embodiment in the first aspect of the present disclosure, the first driving mechanism and the second driving mechanism are staggered in space, and the second driving mechanism comprises a second driving assembly, a third connecting block, a fourth connecting block, a third connecting rod and a fourth connecting rod;
one end of the third connecting rod is fixedly connected with the supporting body, and the other end of the third connecting rod is rotatably connected with the third connecting block;
one end of the fourth connecting rod is fixedly connected with the second connecting member, and the other end of the fourth connecting rod is rotatably connected with the fourth connecting block; and
two ends of the second driving assembly are rotatably connected with the third connecting block and the fourth connecting block respectively, and based on the cross universal joint, the second driving assembly is capable of driving the board body to rotate around the third rotating shaft through extension and retraction.

For the exercise diagnosis and treatment bed according to the embodiment in the first aspect of the present disclosure, the bed body further comprises a bracket module, the bracket module comprises a bed bracket, a fixed mounting position, a plurality of slidable mounting positions and a plurality of sliding mechanisms, the sliding mechanisms are adapted to the slidable mounting positions in number, the sliding mechanisms are used for driving the slidable mounting positions to slide, the fixed mounting position is used for mounting one of the driving modules, and the remaining driving modules are mounted in the slidable mounting positions respectively, so that an interval between adjacent bed board assemblies is adjustable.

For the exercise diagnosis and treatment bed according to the embodiment in the first aspect of the present disclosure, the sliding mechanism comprises a fourth driving assembly, a guide rail and a slider, the guide rail is arranged on the bracket module in a direction parallel to the second direction, the slider is slidably arranged on the guide rail, the driving module is mounted on the slider, and the control module is used for controlling the fourth driving assembly, so that the fourth driving assembly is capable of driving the slider to slide.

For the exercise diagnosis and treatment bed according to the embodiment in the first aspect of the present disclosure, a lifting mechanism is arranged between the underframe and the bracket module, the lifting mechanism comprises at least two lifting assemblies, and the two lifting assemblies are used for driving the bracket module to lift, drop or tilt at a preset angle.

For the exercise diagnosis and treatment bed according to the embodiment in the first aspect of the present disclosure, the bed body further comprises a limiting assembly, and the limiting assembly is used for assisting the bed board assemblies to limit remaining parts of the human body.

For the exercise diagnosis and treatment bed according to the embodiment in the first aspect of the present disclosure, the limiting assembly comprises at least one of the following: a tail board module used for supporting a leg of the human body, an armrest used for supporting an arm of the human body, or a strap used for fixing a chest and a pelvis of the human body.

For the exercise diagnosis and treatment bed according to the embodiment in the first aspect of the present disclosure, the limiting assembly comprises a tail board module used for supporting a leg of the human body, the tail board module comprises a tail bracket used for supporting the leg of the human body, a telescopic mechanism and an angle adjusting rod, one end of the tail bracket is rotatably connected with the bed bracket, one end of the telescopic mechanism is connected with the bed bracket, the other end of the telescopic mechanism is connected with a preset position of the tail bracket, the angle adjusting rod is in touch connection with the telescopic mechanism, and the telescopic mechanism is driven by the angle adjusting rod to adjust a placement angle of the tail bracket.

Additional aspects and advantages of the present disclosure will be given in part in the following description, which will become apparent from the following description or be understood through practice of the present disclosure.

### BRIEF DESCRIPTION OF THE DRAWINGS

The present disclosure is further described hereinafter with reference to the drawings and the embodiments.

FIG. 1 is a schematic structural diagram of an embodiment of the present disclosure;

FIG. 2 is a schematic structural diagram of a bed body in the embodiment of the present disclosure;

FIG. 3 is a schematic structural diagram of a part of driving module in the embodiment of the present disclosure;

FIG. 4 is a schematic structural diagram of connection between a bed board assembly and another part of driving module in the embodiment of the present disclosure;

FIG. 5 is a schematic structural diagram of a bracket module in the embodiment of the present disclosure;

FIG. 6 is a schematic structural diagram of a tail board module in the embodiment of the present disclosure; and

FIG. 7 is a schematic structural diagram of connection between an underframe and a lifting mechanism in the embodiment of the present disclosure.

### REFERENCE NUMERALS

1 refers to bed body, 11 refers to bracket module, 12 refers to bed board assembly, 13 refers to tail board module, and 14 refers to armrest;
1201 refers to supporting body, 1202 refers to cross universal joint, 1203 refers to second connecting member, 1204 refers to first connecting rod, 1205 refers to first connecting block, 1206 refers to second connecting rod, 1207 refers to second connecting block, and 1208 refers to first driving assembly;
1209 refers to third connecting rod, 1210 refers to third connecting block, 1211 refers to fourth connecting rod, 1212 refers to fourth connecting block, and 1213 refers to second driving assembly;
1214 refers to first connecting member, 1215 refers to first connecting plate, 1216 refers to second connecting plate, 1217 refers to third driving assembly, and 1218 refers to board body;
1101 refers to bed bracket, 1102 refers to guide rail, 1103 refers to slider, 1104 refers to fixed mounting position, 1105 refers to motor connecting rod, and 1106 refers to fourth driving assembly;
1301 refers to tail bracket, 1302 refers to tail board, 1303 refers to telescopic mechanism, and 1304 refers to angle adjusting rod; and
2 refers to underframe, 21 refers to lifting mechanism, and 211 refers to lifting assembly.

### DETAILED DESCRIPTION

Embodiments of the present disclosure are described in detail hereinafter, examples of the embodiments are shown in the drawings, and the same or similar reference numerals throughout the drawings denote the same or similar elements or elements having the same or similar functions. The embodiments described hereinafter with reference to the drawings are exemplary, are only intended to explain the present disclosure, and cannot be understood as limiting the present disclosure.

In the description of the present disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for convenience of the description of the present disclosure and simplification of the description instead of indicating or implying that the indicated device or element must have a specific orientation, and be constructed and operated in a specific orientation, and thus should not be understood as a limitation to the present disclosure.

In the description of the present disclosure, “several” means “one or more”, “a plurality of” means “at least two”, “greater than, less than, more than, and the like” are understood as excluding this number, and “above, below and within” are understood as including this number. If there is the description of “first” and “second”, it is only for the purpose of distinguishing technical features, and should not be understood as indicating or implying relative importance, implicitly indicating the number of the indicated technical features or implicitly indicating the order of the indicated technical features.

In the description of the present disclosure, unless otherwise explicitly defined, the terms “setting”, “mounting” and “connecting” should be understood a broad sense, and those skilled in the art can reasonably determine the specific meanings of the above terms in the present disclosure in combination with the specific contents of the technical solution.

With reference to FIG. 1 to FIG. 7, an embodiment in a first aspect of the present disclosure provides an exercise diagnosis and treatment bed, and particularly an exercise diagnosis and treatment bed for helping a patient with rehabilitation, and the exercise diagnosis and treatment bed comprises an underframe 2, a bed body 1 and a control module.

A space at which bed board assemblies 12 are located has a first direction, a second direction and a third direction which are perpendicular to each other, and a first rotating shaft is parallel to the first direction, a second rotating shaft is parallel to the second direction and a third rotating shaft is parallel to the third direction. In other embodiments, the bed board assemblies 12 can be arranged obliquely, so that coordinate systems formed by the first direction, the second direction and the third direction are all inclined correspondingly, so as to adapt to special use occasions. In a preferred embodiment, the first direction is defined as a gravity direction and an up-down direction, the second direction is defined as a front-back direction and the third direction is defined as a left-right direction, so as to form a commonly used rectangular coordinate system, corresponding control program, formula and parameter settings of the control module are all operated on the basis of this rectangular coordinate system, the bed board assemblies 12 are placed horizontally, and continuous movement of the functions such as flexion-extension, lateral bending and rotation of the lumbar vertebra and the cervical vertebra of a patient can be achieved by driving the bed board assemblies 12 through the driving module, and the purpose of exercise treatment is achieved.

The bed body 1 is arranged on the underframe 2, and the bed body 1 comprises a plurality of bed board assemblies 12 and a plurality of driving modules. The bed board assemblies 12 are spaced from each other and used for supporting some preset parts of a human body, the driving modules are adapted to the bed board assemblies 12 in number, and each of the driving modules is used for being connected with and supporting each of the bed board assemblies 12 respectively. The driving module comprises a first driving mechanism, a second driving mechanism and a third driving mechanism, and the first driving mechanism is used for driving the bed board assembly 12 to rotate around the second rotating shaft, the second driving mechanism is used for driving the bed board assembly 12 to rotate around the third rotating shaft, and the third driving mechanism is used for driving the bed board assembly 12 to rotate around the first rotating shaft. The control module is used for controlling at least one of the first driving mechanism, the second driving mechanism or the third driving mechanism, so that actions of the first driving mechanism, the second driving mechanism and the third driving mechanism are independent of each other, and adjacent bed board assemblies 12 are matched with each other according to preset action instructions respectively, so as to achieve continuous movement of the functions such as flexion-extension, lateral bending and rotation of the lumbar vertebra and the cervical vertebra of a patient. The plurality of bed board assemblies 12 are arranged for supporting and fixing a head, a chest and a pelvis of a human body respectively, the plurality of driving modules are adapted to the bed board assemblies 12 respectively, and the driving modules are independently controlled on the basis of the control module, so that the driving modules can adaptively adjust left-right rotation, front-back rotation and plane rotation of the bed board assemblies 12 on the basis of preset logic, and continuous movement of the functions such as flexion-extension, lateral bending and rotation of the lumbar vertebra and the cervical vertebra of a patient is achieved, and the purpose of exercise treatment is achieved, so as to reduce the burden on the hands of a therapist and save time and labor.

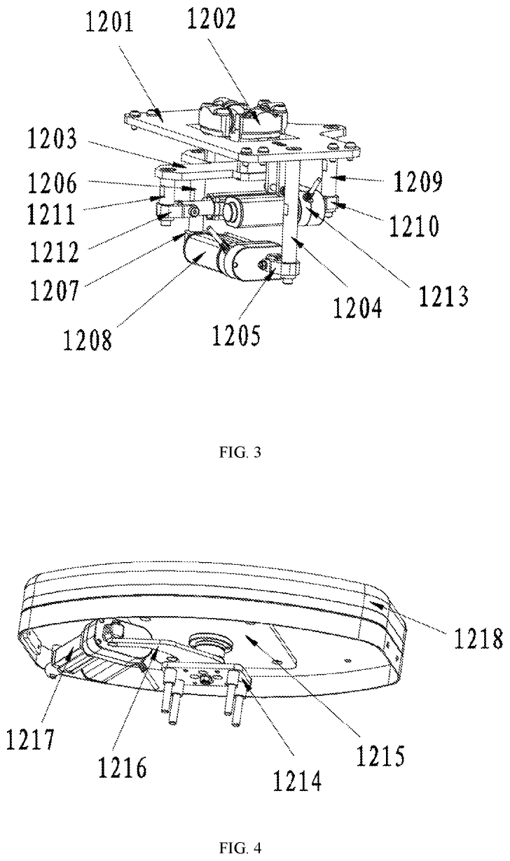

In some embodiments of the present disclosure, specifically, with reference to FIG. 3 and FIG. 4, the bed board assembly 12 comprises a first connecting plate 1215, a first connecting member 1214, a cross universal joint 1202, a supporting body 1201 and a board body 1218 for supporting, the third driving mechanism is arranged on the board body 1218, and the third driving mechanism comprises a third driving assembly 1217 and a second connecting plate 1216. It can be understood that the cross universal joint 1202 allows an included angle between connected parts to change within a certain range, in order to meet the angle change caused by power transmission, steering adaptation and jumping up and down. The cross universal joint 1202, the first driving mechanism and the second driving mechanism are arranged on the supporting body 1201, and the first driving mechanism and the second driving mechanism are connected with the cross universal joint 1202.

Further, specifically, with reference to FIG. 3 and FIG. 4, a top surface of the board body 1218 is used for supporting the human body, so that a bottom surface of the board body 1218 can be used for connection. The first connecting plate 1215 used as an intermediate transition member for connecting the board body 1218 and the driving module is arranged at a bottom portion of the board body 1218, so that the first connecting plate 1215 is fixedly connected with the board body 1218. The first connecting member 1214 is rotatably connected with the first connecting plate 1215 with the first rotating shaft as a rotating axis, one end of the first connecting member 1214 is used for supporting the board body 1218, and the other end of the first connecting member 1214 is connected with the cross universal joint 1202, so that the first driving mechanism and the second driving mechanism are capable of driving the bed board assembly 12 to rotate around the second rotating shaft and the third rotating shaft respectively.

Preferably, with reference to FIG. 4, a specific structure of the first connecting member 1214 can be designed specifically, a bottom end of the first connecting member 1214 can be set as a structure conveniently connecting to the cross universal joint 1202, such as a structure of four connecting feet, and a top end of the first connecting member 1214 can be set as a flat surface conveniently connecting to the board body 1218. Based on the connection of the four connecting feet and the cross universal joint 1202, the first driving mechanism and the second driving mechanism are capable of driving the bed board assembly 12 to rotate around the second rotating shaft and the third rotating shaft respectively. Based on the flat surface, it is ensured that the board body 1218 can still work normally when rotating around the second rotating shaft and the third rotating shaft. Based on the rotational connection of the first connecting member 1214 and the first connecting plate 1215, the board body 1218 does not affect the normal work of the first driving mechanism and the second driving mechanism when rotating around the first rotating shaft. Therefore, the second connecting plate 1216 is fixedly connected with the first connecting member 1214, two ends of the third driving assembly 1217 are rotatably connected with the first connecting plate 1215 and the second connecting plate 1216 respectively, and based on fixed connection of the second connecting plate 1216, the third driving mechanism is capable of driving the first connecting plate 1215 to rotate the board body 1218 around the first rotating shaft through extension and retraction.

In some embodiments of the present disclosure, specifically, with reference to FIG. 3, the first driving mechanism comprises a first driving assembly 1208, a first connecting block 1205, a second connecting block 1207, a first connecting rod 1204, a second connecting rod 1206 and a second connecting member 1203. It can be understood that the supporting body 1201 used as a bearing platform is always kept in a relatively fixed state, and in order to ensure a bearing effect, the supporting body 1201 can be preferably arranged horizontally, the cross universal joint 1202 can be movably arranged on the supporting body 1201, the second connecting member 1203 receives a transmitted driving force and outputs the driving force to the cross universal joint 1202, and the first connecting rod 1204 and the second connecting rod 1206 are used for transmitting a torque of the first driving assembly 1208, so that the first connecting block 1205 and the second connecting block 1207 are used as intermediate members for rotational connection.

Specifically, with reference to FIG. 3 and FIG. 4, one cross edge of the cross universal Joint 1202 is fixedly connected with the supporting body 1201, and the other cross edge of the cross universal joint is fixedly connected with the first connecting member 1214 and the second connecting member 1203. One end of the first connecting rod 1204 is fixedly connected with the supporting body 1201, and the other end of the first connecting rod 1204 is rotatably connected with the first connecting block 1205. One end of the second connecting rod 1206 is fixedly connected with the second connecting member 1203, and the other end of the second connecting rod 1206 is rotatably connected with the second connecting block 1207. Two ends of the first driving assembly 1208 are rotatably connected with the first connecting block 1205 and the second connecting block 1207 respectively, and based on the cross universal joint 1202, the first driving assembly 1208 is capable of driving the board body 1218 to rotate around the second rotating shaft through extension and retraction. The first driving assembly 1208 outputs the driving force to the first connecting member 1214 along the cross universal joint 1202, so that an effect of driving the board body 1218 to rotate is achieved.

In some embodiments of the present disclosure, specifically, with reference to FIG. 3, the first driving mechanism and the second driving mechanism are staggered in space, and the second driving mechanism comprises a second driving assembly 1213, a third connecting block 1210, a fourth connecting block 1212, a third connecting rod 1209 and a fourth connecting rod 1211. It can be understood that the first driving mechanism and the second driving mechanism are similar in connection mode, the first driving mechanism and the second driving mechanism are both located at a bottom portion of the board body 1218, and the first connecting rod 1204, the second connecting rod 1206, the second connecting member 1203, the third connecting rod and the fourth connecting rod 1211 do not interfere with each other, so as to ensure reasonable transmission.

Specifically, one end of the third connecting rod 1209 is fixedly connected with the supporting body 1201, and the other end of the third connecting rod 1209 is rotatably connected with the third connecting block 1210. One end of the fourth connecting rod 1211 is fixedly connected with the second connecting member 1203, and the other end of the fourth connecting rod 1211 is rotatably connected with the fourth connecting block 1212. Two ends of the second driving assembly 1213 are rotatably connected with the third connecting block 1210 and the fourth connecting block 1212 respectively, and based on the cross universal joint 1202, the second driving assembly 1213 is capable of driving the board body 1218 to rotate around the third rotating shaft through extension and retraction. The second driving assembly 1213 outputs the driving force to the first connecting member 1214 along the cross universal joint 1202, so that an effect of driving the board body 1218 to rotate is achieved.

In a preferred embodiment, the first driving assembly 1208, the second driving assembly 1213 and the third driving assembly 1217 can all be set as a telescopic motor, so as to drive the board body 1218 to rotate in multiple directions under the condition of reducing an overall volume. In some embodiments, the first driving assembly 1208, the second driving assembly 1213 and the third driving assembly 1217 can be set in a structural form that the motors are connected and matched with a telescopic transmission member, and the board body 1218 can also be driven to rotate through extension and retraction of the telescopic transmission member, which is not further limited herein.

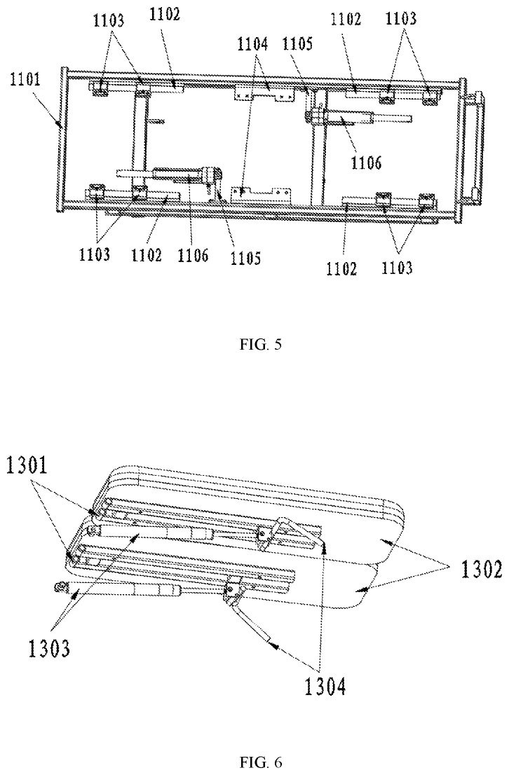

In some embodiments of the present disclosure, specifically, with reference to FIG. 5, the bed body 1 further comprises a bracket module 11, the bracket module 11 is used for bearing various driving modules, and the driving modules are connected with and bear the bed board assemblies 12, so that the bed board assemblies 12 can be used for bearing the human body. The bracket module 11 comprises a bed bracket 1101, a fixed mounting position 1104, a plurality of slidable mounting positions and a plurality of sliding mechanisms. The sliding mechanisms are adapted to the slidable mounting positions in number, the sliding mechanisms are used for driving the slidable mounting positions to slide, the fixed mounting position 1104 is used for mounting one of the driving modules, and the remaining driving modules are mounted in the slidable mounting positions respectively, so that an interval between adjacent bed board assemblies 12 is adjustable. In a preferred embodiment, three driving modules and three bed board assemblies 12 are provided for supporting and fixing corresponding head, chest and pelvis of the human body respectively, so that the fixed mounting position 1104 is arranged in a middle portion, the slidable mounting positions are located on two sides of the fixed mounting position 1104, and the sliding mechanisms are also arranged on two sides of the fixed mounting position 1104 respectively and connected with the slidable mounting positions respectively. The slidable mounting positions are driven to slide through the sliding mechanisms, so that horizontal movement of front and rear bed board assemblies 12 can be achieved, the bed board assemblies can be adjusted to adapt to the height of a patient, and the bed board assemblies can also be used for pulling a lumbar vertebra and a cervical vertebra of the patient.

Specifically, continuously referring to FIG. 5, the sliding mechanism comprises a fourth driving assembly 1106, a guide rail 1102 and a slider 1103. The guide rail 1102 is arranged on the bracket module 11 in a direction parallel to the second direction, so as to adapt to the adjustment in a height direction of the patient and ensure the achievement of the function of pulling the lumbar vertebra and the cervical vertebra. The slider 1103 is slidably arranged on the guide rail 1102, by controlling a machining accuracy of the guide rail 1102 and a machining mode of the guide rail 1102, the slider 1103 can be ensured to slide stably and accurately, and by mounting the driving module and the bed board assembly 12 on the slider 1103 respectively, one slider 1103 correspondingly bears one driving module and one bed board assembly 12, so that based on a control mode of the fourth driving assembly 1106 by the control module, the fourth driving assembly 1106 is capable of driving the slider 1103 to slide according to preset instruction and logical action. Preferably, the fourth driving assembly 1106 comprises a telescopic motor and a motor connecting rod 1105, two ends of the telescopic motor are rotatably connected with two motor connecting rods 1105 respectively, and the two motor connecting rods 1105 are connected with the slider 1103 and the bed bracket 1101 respectively, so that the slider 1103 is driven to slide back and forth through extension and retraction.

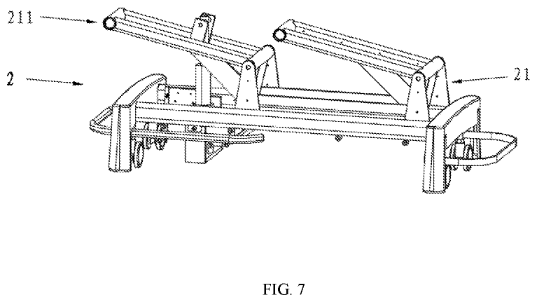

In some embodiments of the present disclosure, specifically, with reference to FIG. 1 and FIG. 7, a lifting mechanism 21 is arranged between the underframe 2 and the bracket module 11, and the lifting mechanism 21 can adjust a height of the bed body 1, thus being convenient for a therapist to use. Specifically, the lifting mechanism 21 comprises at least two lifting assemblies 211, and the two lifting assemblies 211 are used for driving the bracket module 11 to lift, drop or tilt at a preset angle. It can be understood that the two lifting assemblies 211 execute the same command and action in an initial state, so that the bracket module 11 can be lifted and dropped smoothly, and the two lifting assemblies 211 execute different actions independently, so that an inclination angle can be adjusted. Specific control can be performed according to actual use requirements herein.

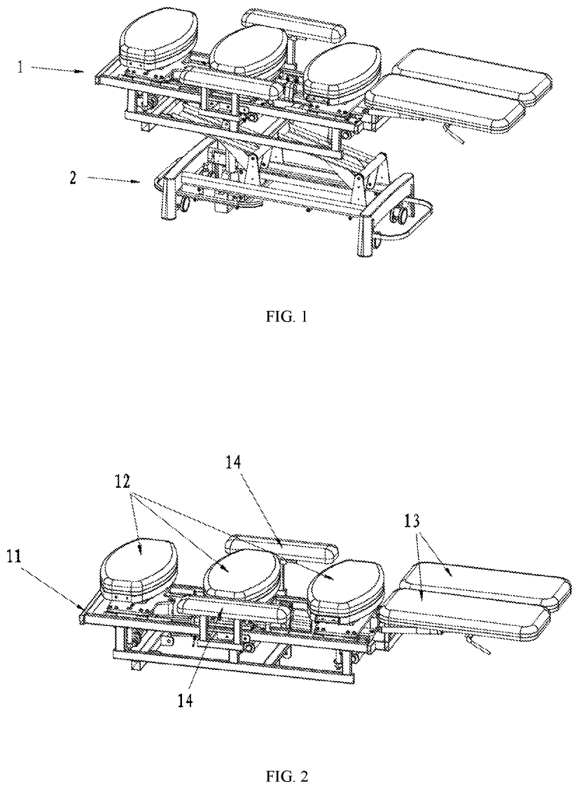

In some embodiments of the present disclosure, specifically, with reference to FIG. 1 and FIG. 2, the bed body 1 further comprises a limiting assembly, and the limiting assembly is used for assisting the bed board assemblies 12 to limit remaining parts of the human body. Specifically, the limiting assembly comprises at least one of the following: a tail board module 13 used for supporting a leg of the human body, an armrest 14 used for supporting an arm of the human body, or a strap used for fixing a chest and a pelvis of the human body. It can be understood that the tail board modules 13 are arranged at a tail portion of the bed board assemblies 12, the armrests 14 are arranged on two sides of the bed board assemblies 12 respectively, and multiple groups of straps may be provided according to use requirements, which are located near the bed board assemblies 12 respectively to fix the chest and the pelvis of the human body.

Specifically, with reference to FIG. 6, the tail board module 13 comprises a tail bracket 1301 used for supporting the leg of the human body, a telescopic mechanism 1303 and an angle adjusting rod 1304, one end of the tail bracket 1301 is rotatably connected with the bed bracket 1101, one end of the tail bracket 1301 is used as a basic point of swinging, and subsequent swinging adjustments of the tail bracket 1301 are all based on this end. A tail board 1302 is placed on the tail bracket 1301, one end of the telescopic mechanism 1303 is connected with the bed bracket 1101, and the other end of the telescopic mechanism 1303 is connected with a preset position of the tail bracket 1301. The telescopic mechanism 1303 encloses a triangular closed structure with the bed bracket 1101 and the tail bracket 1301. The angle adjusting rod 1304 is in touch connection with the telescopic mechanism 1303, and the telescopic mechanism 1303 is driven by the angle adjusting rod 1304 to adjust a placement angle of the tail bracket 1301. The angle adjusting rod 1304 can be adjusted manually, and can also be externally connected with an adjusting module, and the adjusting module can be controlled through the control module for adjustment, which is not further limited herein.

Various technical features of the above embodiments can be combined randomly, and in order to simplify the description, possible combinations of various technical features in the above embodiments are not all described. However, as long as the combinations of these technical features have no contradiction, the combinations of these technical features should be considered as falling into the scope recorded by the specification.

The embodiments of the present disclosure are described in detail with reference to the drawings above, but the present disclosure is not limited to the above embodiments, and various changes can also be made within the knowledge scope of those of ordinary skills in the art without departing from the purpose of the present disclosure.

1. An exercise diagnosis and treatment bed, comprising:
an underframe;
a bed body arranged on the underframe, wherein the bed body comprises a plurality of bed board assemblies and a plurality of driving modules, the bed board assemblies are spaced from each other and used for supporting preset parts of a human body, the driving modules are adapted to the bed board assemblies in number, and each of the driving modules is used for being connected with and supporting each of the bed board assemblies;
wherein a space at which the bed board assemblies are located has a first direction, a second direction and a third direction which are perpendicular to each other, and a first rotating shaft is parallel to the first direction, a second rotating shaft is parallel to the second direction and a third rotating shaft is parallel to the third direction;
wherein the driving module comprises a first driving mechanism, a second driving mechanism and a third driving mechanism, the first driving mechanism is used for driving the bed board assembly to rotate around the second rotating shaft, the second driving mechanism is used for driving the bed board assembly to rotate around the third rotating shaft, and the third driving mechanism is used for driving the bed board assembly to rotate around the first rotating shaft; and
a control module used for controlling at least one of the first driving mechanism, the second driving mechanism or the third driving mechanism.

2. The exercise diagnosis and treatment bed according to claim 1, wherein the bed board assembly comprises a first connecting plate, a first connecting member, a cross universal joint, a supporting body and a board body for supporting, the third driving mechanism is arranged on the board body, and the third driving mechanism comprises a third driving assembly and a second connecting plate;
the cross universal joint, the first driving mechanism and the second driving mechanism are arranged on the supporting body, and the first driving mechanism and the second driving mechanism are connected with the cross universal joint;
the first connecting plate is fixedly connected with the board body, the first connecting member is rotatably connected with the first connecting plate with the first rotating shaft as a rotating axis, and one end of the first connecting member is used for supporting the board body;
the other end of the first connecting member is connected with the cross universal joint, resulting in that the first driving mechanism and the second driving mechanism are capable of driving the bed board assembly to rotate around the second rotating shaft and the third rotating shaft respectively; and
the second connecting plate is fixedly connected with the first connecting member, two ends of the third driving assembly are rotatably connected with the first connecting plate and the second connecting plate respectively, and based on fixed connection of the second connecting plate, the third driving mechanism is capable of driving the first connecting plate to rotate the board body around the first rotating shaft through extension and retraction.

3. The exercise diagnosis and treatment bed according to claim 2, wherein the first driving mechanism comprises a first driving assembly, a first connecting block, a second connecting block, a first connecting rod, a second connecting rod and a second connecting member;
one cross edge of the cross universal joint is fixedly connected with the supporting body, and the other cross edge of the cross universal joint is fixedly connected with the first connecting member and the second connecting member;
one end of the first connecting rod is fixedly connected with the supporting body, and the other end of the first connecting rod is rotatably connected with the first connecting block;
one end of the second connecting rod is fixedly connected with the second connecting member, and the other end of the second connecting rod is rotatably connected with the second connecting block; and
two ends of the first driving assembly are rotatably connected with the first connecting block and the second connecting block respectively, and based on the cross universal joint, the first driving assembly is capable of driving the board body to rotate around the second rotating shaft through extension and retraction.

4. The exercise diagnosis and treatment bed according to claim 3, wherein the first driving mechanism and the second driving mechanism are staggered in space, and the second driving mechanism comprises a second driving assembly, a third connecting block, a fourth connecting block, a third connecting rod and a fourth connecting rod;
one end of the third connecting rod is fixedly connected with the supporting body, and the other end of the third connecting rod is rotatably connected with the third connecting block;
one end of the fourth connecting rod is fixedly connected with the second connecting member, and the other end of the fourth connecting rod is rotatably connected with the fourth connecting block; and
two ends of the second driving assembly are rotatably connected with the third connecting block and the fourth connecting block respectively, and based on the cross universal joint, the second driving assembly is capable of driving the board body to rotate around the third rotating shaft through extension and retraction.

5. The exercise diagnosis and treatment bed according to claim 1, wherein the bed body further comprises a bracket module, the bracket module comprises a bed bracket, a fixed mounting position, a plurality of slidable mounting positions and a plurality of sliding mechanisms, the sliding mechanisms are adapted to the slidable mounting positions in number, the sliding mechanisms are used for driving the slidable mounting positions to slide, the fixed mounting position is used for mounting one of the driving modules, and the remaining driving modules are mounted in the slidable mounting positions respectively, resulting in that an interval between adjacent bed board assemblies is adjustable.

6. The exercise diagnosis and treatment bed according to claim 5, wherein the sliding mechanism comprises a fourth driving assembly, a guide rail and a slider, the guide rail is arranged on the bracket module in a direction parallel to the second direction, the slider is slidably arranged on the guide rail, the driving module is mounted on the slider, and the control module is used for controlling the fourth driving assembly, resulting in that the fourth driving assembly is capable of driving the slider to slide.

7. The exercise diagnosis and treatment bed according to claim 5, wherein a lifting mechanism is arranged between the underframe and the bracket module, the lifting mechanism comprises at least two lifting assemblies, and the two lifting assemblies are used for driving the bracket module to lift, drop or tilt at a preset angle.

8. The exercise diagnosis and treatment bed according to claim 5, wherein the bed body further comprises a limiting assembly, and the limiting assembly is used for assisting the bed board assemblies to limit remaining parts of the human body.

9. The exercise diagnosis and treatment bed according to claim 8, wherein the limiting assembly comprises at least one of the following: a tail board module used for supporting a leg of the human body, an armrest used for supporting an arm of the human body, or a strap used for fixing a chest and a pelvis of the human body.

10. The exercise diagnosis and treatment bed according to claim 8, wherein the limiting assembly comprises a tail board module used for supporting a leg of the human body, the tail board module comprises a tail bracket used for supporting the leg of the human body, a telescopic mechanism and an angle adjusting rod, and wherein one end of the tail bracket is rotatably connected with the bed bracket, one end of the telescopic mechanism is connected with the bed bracket, the other end of the telescopic mechanism is connected with a preset position of the tail bracket, the angle adjusting rod is in touch connection with the telescopic mechanism, and the telescopic mechanism is driven by the angle adjusting rod to adjust a placement angle of the tail bracket.

11. The exercise diagnosis and treatment bed according to claim 2, wherein the bed body further comprises a bracket module, the bracket module comprises a bed bracket, a fixed mounting position, a plurality of slidable mounting positions and a plurality of sliding mechanisms, the sliding mechanisms are adapted to the slidable mounting positions in number, the sliding mechanisms are used for driving the slidable mounting positions to slide, the fixed mounting position is used for mounting one of the driving modules, and the remaining driving modules are mounted in the slidable mounting positions respectively, resulting in that an interval between adjacent bed board assemblies is adjustable.

12. The exercise diagnosis and treatment bed according to claim 11, wherein the sliding mechanism comprises a fourth driving assembly, a guide rail and a slider, the guide rail is arranged on the bracket module in a direction parallel to the second direction, the slider is slidably arranged on the guide rail, the driving module is mounted on the slider, and the control module is used for controlling the fourth driving assembly, resulting in that the fourth driving assembly is capable of driving the slider to slide.

13. The exercise diagnosis and treatment bed according to claim 3, wherein the bed body further comprises a bracket module, the bracket module comprises a bed bracket, a fixed mounting position, a plurality of slidable mounting positions and a plurality of sliding mechanisms, the sliding mechanisms are adapted to the slidable mounting positions in number, the sliding mechanisms are used for driving the slidable mounting positions to slide, the fixed mounting position is used for mounting one of the driving modules, and the remaining driving modules are mounted in the slidable mounting positions respectively, resulting in that an interval between adjacent bed board assemblies is adjustable.

14. The exercise diagnosis and treatment bed according to claim 13, wherein the sliding mechanism comprises a fourth driving assembly, a guide rail and a slider, the guide rail is arranged on the bracket module in a direction parallel to the second direction, the slider is slidably arranged on the guide rail, the driving module is mounted on the slider, and the control module is used for controlling the fourth driving assembly, resulting in that the fourth driving assembly is capable of driving the slider to slide.

15. The exercise diagnosis and treatment bed according to claim 4, wherein the bed body further comprises a bracket module, the bracket module comprises a bed bracket, a fixed mounting position, a plurality of slidable mounting positions and a plurality of sliding mechanisms, the sliding mechanisms are adapted to the slidable mounting positions in number, the sliding mechanisms are used for driving the slidable mounting positions to slide, the fixed mounting position is used for mounting one of the driving modules, and the remaining driving modules are mounted in the slidable mounting positions respectively, resulting in that an interval between adjacent bed board assemblies is adjustable.

16. The exercise diagnosis and treatment bed according to claim 15, wherein the sliding mechanism comprises a fourth driving assembly, a guide rail and a slider, the guide rail is arranged on the bracket module in a direction parallel to the second direction, the slider is slidably arranged on the guide rail, the driving module is mounted on the slider, and the control module is used for controlling the fourth driving assembly, resulting in that the fourth driving assembly is capable of driving the slider to slide.
